(19) United States
(12) Patent Application Publication
(10) Pub. No.: US 2017/0325199 A1
(43) Pub. Date: Nov. 9, 2017

(54) WLAN/BT/802.15.4 COEXISTENCE INTERFACE

(71) Applicant: QUALCOMM Incorporated, San Diego, CA (US)

(72) Inventors: Olaf Josef Hirsch, Sunnyvale, CA (US); Chen Chen, Sunnyvale, CA (US)

(21) Appl. No.: 15/206,567

(22) Filed: Jul. 11, 2016

Related U.S. Application Data
(60) Provisional application No. 62/332,737, filed on May 6, 2016.

(51) Int. Cl. H04W 72/02; H04W 4/00; H04W 88/06; H04W 72/04

(52) U.S. Cl. CPC H04W 72/02; H04W 4/008; H04W 88/06; H04W 72/0413

(57) ABSTRACT

A coexistence interface for arbitrating wireless communications among a plurality of wireless radios of a wireless device. The coexistence interface includes a first set of inputs to receive first signals indicating transmit or receive activity of a first wireless radio of the wireless device. The coexistence interface includes a second set of inputs to receive second signals indicating transmit or receive activity of a second wireless radio of the wireless device. The coexistence interface further includes arbitration logic to prioritize transmit or receive activity of a third wireless radio of the wireless device based at least in part on the first and second signals.

### CROSS-REFERENCE TO RELATED APPLICATIONS

This application claims priority under 35 USC 119(e) to co-pending and commonly owned U.S. Provisional Patent Application No. 62/332,737 entitled “WLAN/BT/802.15.4 COEXISTENCE INTERFACE,” filed on May 6, 2016, the entirety of which is incorporated by reference herein.

### TECHNICAL FIELD

The present embodiments relate generally to wireless networks, and specifically to a coexistence interface for wireless networks implementing WLAN, Bluetooth, 802.15.4 communications, and/or other similar wireless personal area network (WPAN) protocols.

### BACKGROUND OF RELATED ART

The Internet of Things (IoT) is a technology that enables interconnectivity to a broad spectrum of devices and objects. Certain devices in an IoT network may provide key services (e.g., connectivity, authentication, configuration/admission control, etc.) to other devices in the network. For example, IoT networks typically operate in an “infrastructure mode” for which an access point (AP), acting as a wireless hub, provides a shared wireless communication medium for use by a number of client devices. In infrastructure mode, most (if not all) communications in the IoT network are routed through the AP. For example, the AP may be coupled to a back-end Internet connection and may thus provide Internet connectivity to each of the client devices in an IoT network.

IoT devices may communicate wirelessly with one another based on a variety of wireless communication protocols. For example, wireless stations (e.g., computers, smartphones, tablets, etc.) may communicate with the AP using Wi-Fi protocols defined by the IEEE 802.11 standard, whereas low-power devices may communicate with the AP using Bluetooth protocols and/or other wireless protocols, such as defined by the IEEE 802.15.4 standard (e.g., ZigBee, Thread, Z-Wave, etc.). Most, if not all, of these wireless protocols utilize the 2.4 GHz frequency spectrum for communications. Thus, it may be desirable to control or arbitrate wireless communications between the different wireless technologies to prevent or mitigate signal interference.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

A coexistence interface for arbitrating wireless communications among a plurality of wireless radios of a wireless device is disclosed. The coexistence interface includes a first set of inputs to receive first signals indicating transmit or receive activity of a first wireless radio of the wireless device. The coexistence interface includes a second set of inputs to receive second signals indicating transmit or receive activity of a second wireless radio of the wireless device. The coexistence interface further includes arbitration logic to prioritize transmit or receive activity of a third wireless radio of the wireless device based at least in part on the first and second signals.

The first wireless radio may operate in accordance with a first wireless communications protocol, and the second wireless radio may operate in accordance with a second wireless communications protocol that is different than the first wireless communications protocol. For example, the first wireless communications protocol may be a Bluetooth protocol and the second wireless communications protocol may be a wireless personal area network (WPAN) protocol defined by the IEEE 802.15.4 standard. For some embodiments, the coexistence interface may adjust the transmit or receive activity of the first wireless radio based at least in part on the second signals.

The third wireless radio may operate in accordance with a third wireless communications protocol that is different than the first and second wireless communications protocols. For example, the third wireless communications protocol may be a wireless local area network (WLAN) or Wi-Fi protocol defined by the IEEE 802.11 standard. For some embodiments, the third wireless radio may be a legacy Wi-Fi radio (e.g., without built-in coexistence functionality).

The coexistence interface may further include a third set of inputs to receive third signals indicating transmit or receive activity of the third wireless radio. The first, second, and third signals may further indicate a corresponding priority of the transmit or receive activity of the first, second, and third wireless radios, respectively. For some embodiments, the arbitration logic may include a plurality of logic gates to generate a control signal based on a logical combination of the first, second, and third signals.

The arbitration logic may prioritize the transmit or receive activity of the third wireless radio by selectively outputting the control signal to the third wireless radio. For example, the arbitration logic may disable the transmit or receive activity of the third wireless radio by asserting the control signal. On the other hand, the coexistence interface may enable the transmit or receive activity of the third wireless radio by deasserting the control signal. In some embodiments, the arbitration logic may be coupled to a power amplifier of the third wireless radio, to selectively activate or deactivate the power amplifier based on the control signal.

### BRIEF DESCRIPTION OF THE DRAWINGS

The present embodiments are illustrated by way of example and are not intended to be limited by the figures of the accompanying drawings.

FIG. 1 shows an example wireless network system within which the example embodiments may be implemented.

FIG. 2 is a block diagram of a wireless hub in accordance with example embodiments.

FIGS. 3A-3B show circuit diagrams of respective coexistence interfaces in accordance with example embodiments.

FIG. 4 is a block diagram of a Wi-Fi radio in accordance with example embodiments.

FIG. 5 is a block diagram of a coexistence interface in accordance with example embodiments.

FIG. 6 is an illustrative flow chart depicting an example operation of a coexistence interface in accordance with example embodiments.

### DETAILED DESCRIPTION

The example embodiments are described below in the context of wireless hubs for simplicity only. It is to be understood that the example embodiments are equally applicable to other wireless networks (e.g., cellular networks, pico networks, femto networks, satellite networks, etc.), as well as for systems using signals of one or more wired standards or protocols (e.g., Ethernet and/or HomePlug/PLC standards). As used herein, the terms “wireless local area network,” “WLAN,” and “Wi-Fi” may refer to communications governed by the IEEE 802.11 standards. The term “Bluetooth” may refer to communications governed by the BLUETOOTH® standards. The terms “wireless personal area network” and “WPAN” may refer to communications governed by the IEEE 802.15.4 standards (e.g., ZigBee, Thread, Z-Wave, etc.). A wireless network, as described herein, may include communications governed by Wi-Fi, Bluetooth, WPAN, HiperLAN (a set of wireless standards, comparable to the IEEE 802.11 standards, used primarily in Europe), and/or other technologies used in wireless communications.

In addition, although described below in terms of an infrastructure wireless network system including one or more wireless hubs and a number of client devices, the example embodiments are equally applicable to other wireless network systems including, for example, multiple wireless networks, peer-to-peer systems, Independent Basic Service Set (IBSS) systems, Wi-Fi Direct systems, and/or Hotspots. Further, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs).

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

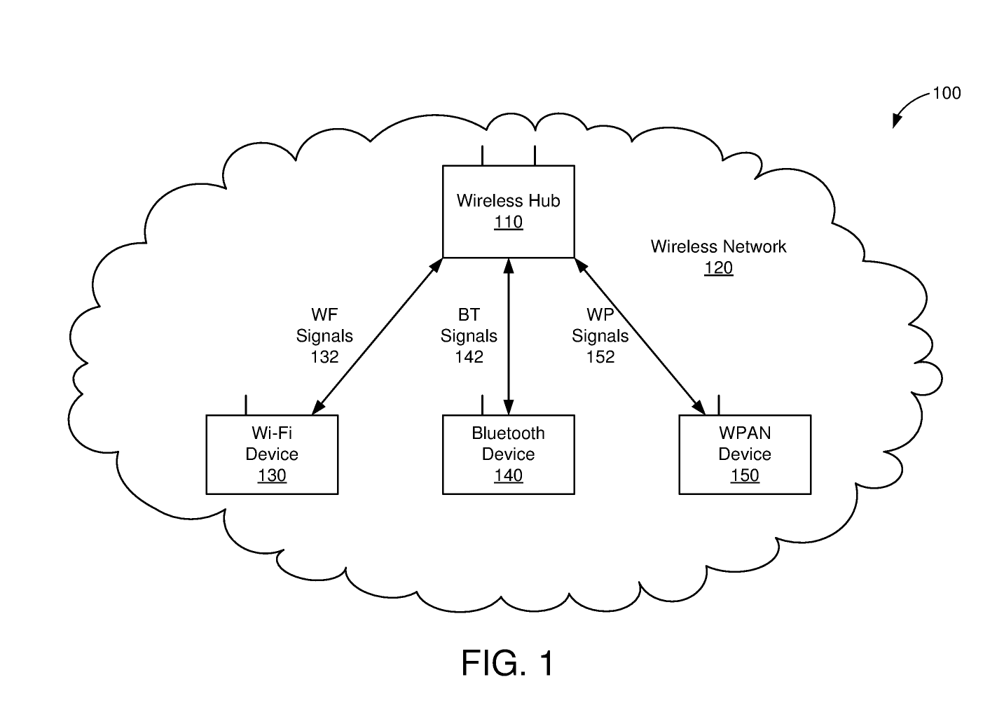

FIG. 1 shows an example wireless network system 100 within which the example embodiments may be implemented. The wireless system 100 is shown to include a wireless hub 110, a wireless network 120, and three client devices 130-150. The wireless network 120 may be formed by a plurality of wireless hubs that may operate according to various wireless protocols (e.g., IEEE 802.11, IEEE 802.15.4, Bluetooth, etc.). Thus, although only one wireless hub 110 is shown in FIG. 1 for simplicity, it is to be understood that wireless network 120 may be formed by any number of wireless hubs such as wireless hub 110.

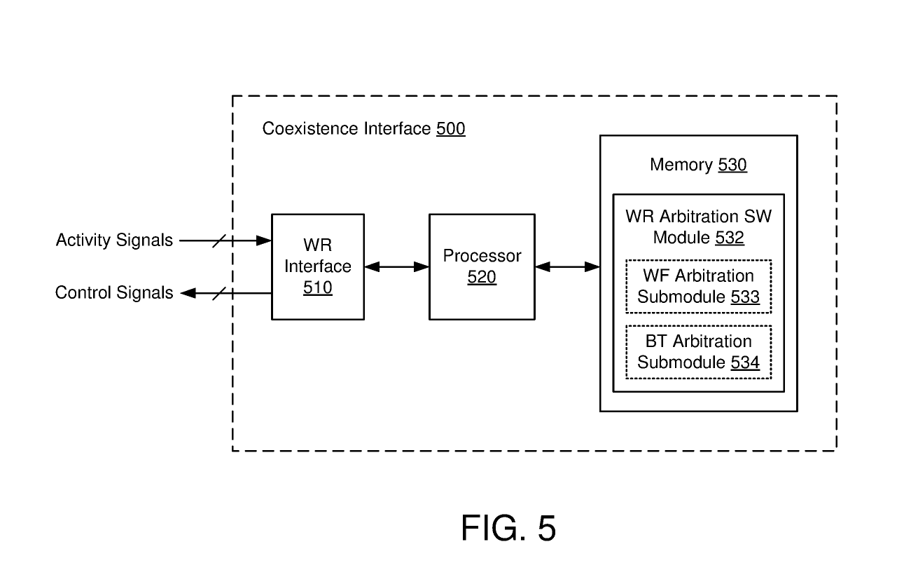

The wireless hub 110 may be any suitable device that allows one or more wireless devices to connect to a network (e.g., a wireless local area network (WLAN), wireless personal area network (WPAN), wide area network (WAN), metropolitan area network (MAN), and/or the Internet) via wireless hub 110 using Wi-Fi, Bluetooth, WPAN (e.g., ZigBee, Thread, Z-Wave, etc.), or any other suitable wireless communications protocols. For at least one embodiment, wireless hub 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 5.

The client devices may include a Wi-Fi device 130, a Bluetooth device 140, and a WPAN device 150. The Wi-Fi device 130 may communicate with the wireless hub 110 using Wi-Fi (WF) signals 132, in accordance with IEEE 802.11 protocols. The Bluetooth device 140 may communicate with the wireless hub 110 using Bluetooth (BT) signals 142, in accordance with Bluetooth protocols. The WPAN device 150 may communicate with the wireless hub 110 using WPAN (WP) signals 152, in accordance with IEEE 802.15.4 protocols (e.g., ZigBee, Thread, Z-Wave, etc.). Each of the client devices 130-150 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that store instructions for communicating with the wireless hub 110 and/or accessing the wireless network 120.

Each of the client devices 130-150 may include one or more wireless radios (not shown for simplicity) to transmit and receive wireless signals in accordance with their respective communications protocols. For example, the Wi-Fi device 130 may include one or more Wi-Fi radios, the Bluetooth device 140 may include one or more Bluetooth radios, and the WPAN device 150 may include one or more WPAN radios. The wireless hub 110 may include a plurality of wireless radios to communicate with each of the client devices 130-150. Thus, the wireless hub 110 may include at least a Wi-Fi radio, a Bluetooth radio, and WPAN radio. The various wireless radios (e.g., Wi-Fi, Bluetooth, and WPAN) may operate within the same frequency band (e.g., 2.4 GHz).

The example embodiments recognize that, due to the overlapping frequency band, communications between the wireless hub 110 and one of the client devices 130-150 may interfere with communications between the wireless hub 110 and other client devices 130-150. The interference may be more pronounced at the wireless hub 110, for example, due to the relatively close proximity of the various wireless radios of the wireless hub 110. Thus, it may be desirable to prevent the wireless hub 110 from communicating with multiple client devices 130-150 concurrently (e.g., using different wireless communication technologies).

In example embodiments, the wireless hub 110 may include wireless coexistence circuitry to ensure that the wireless hub 110 communicates with the client devices 130-150 using only one wireless technology (e.g., Wi-Fi. Bluetooth, WPAN, etc.) at any given time. More generally, the example embodiments may be used to prioritize wireless communication technologies in a hierarchical manner, such that higher-priority wireless communications take precedence over lower-priority wireless communications. For example, the coexistence circuitry may prevent or disable one or more of the wireless radios of the wireless hub 110 from transmitting and/or receiving wireless signals while one or more other wireless radios of the wireless hub 110 is transmitting and/or receiving wireless signals.

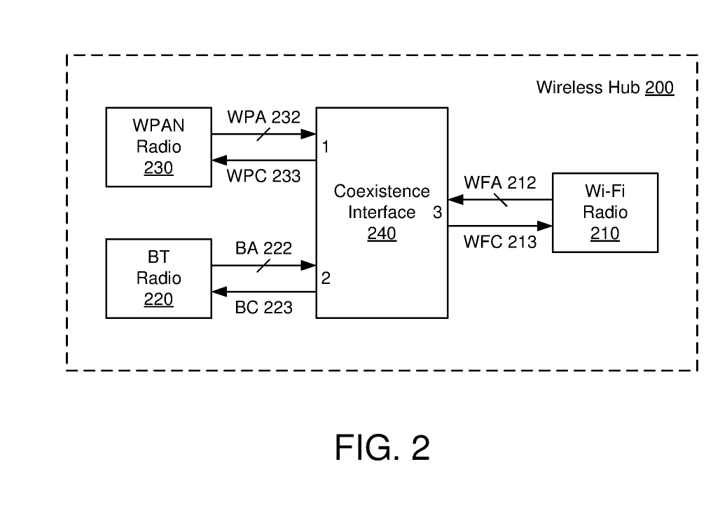

FIG. 2 is a block diagram of a wireless hub 200 in accordance with example embodiments. The wireless hub 200 may be one embodiment of the wireless hub 110 of FIG. 1. Thus, the wireless hub 200 may provide access to a wireless network (e.g., wireless network 120), and may communicate with a plurality of client devices using various wireless protocols, such as Wi-Fi, Bluetooth, WPAN, and/or other wireless protocols (e.g., such as defined by the IEEE 802.15.4 specification). The wireless hub 200 includes a Wi-Fi radio 210, a Bluetooth (BT) radio 220, a WPAN radio 230, and a coexistence interface 240.

The coexistence interface 240 is coupled to the WPAN radio 230 via a first set of inputs and outputs (1). The coexistence interface 240 is further coupled to the Bluetooth radio 220 via a second set of inputs and outputs (2). Still further, the coexistence interface 240 is coupled to the Wi-Fi radio 210 via a third set of inputs and outputs (3). In example embodiments, the coexistence interface 240 may control and/or arbitrate wireless activity from each of the wireless radios 210, 220, and 230. As described above, the coexistence interface 240 may reduce interference among the wireless radios 210, 220, and 230, for example, by preventing multiple wireless radios from transmitting and/or receiving wireless communications at substantially the same time. Further, the example embodiments recognize that most (if not all) Bluetooth radios and WPAN radios are preconfigured to support coexistence, whereas many legacy Wi-Fi radios may not have coexistence support. Thus, in some aspects, the coexistence interface 240 may enable coexistence for legacy wireless radios and/or wireless radios without built-in coexistence functionality.

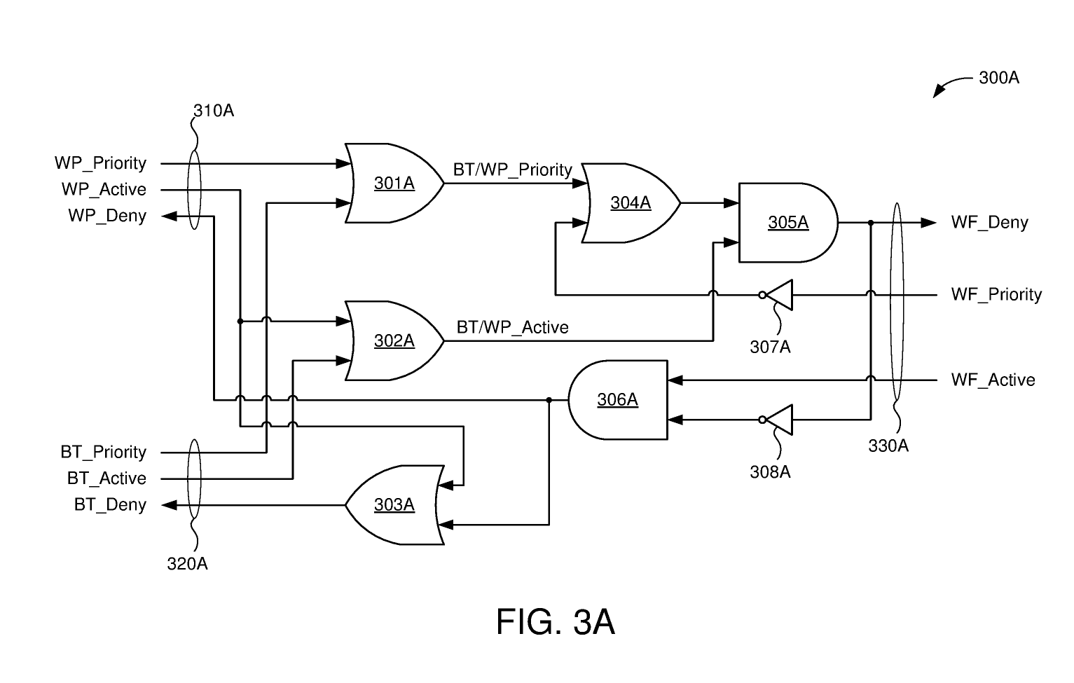

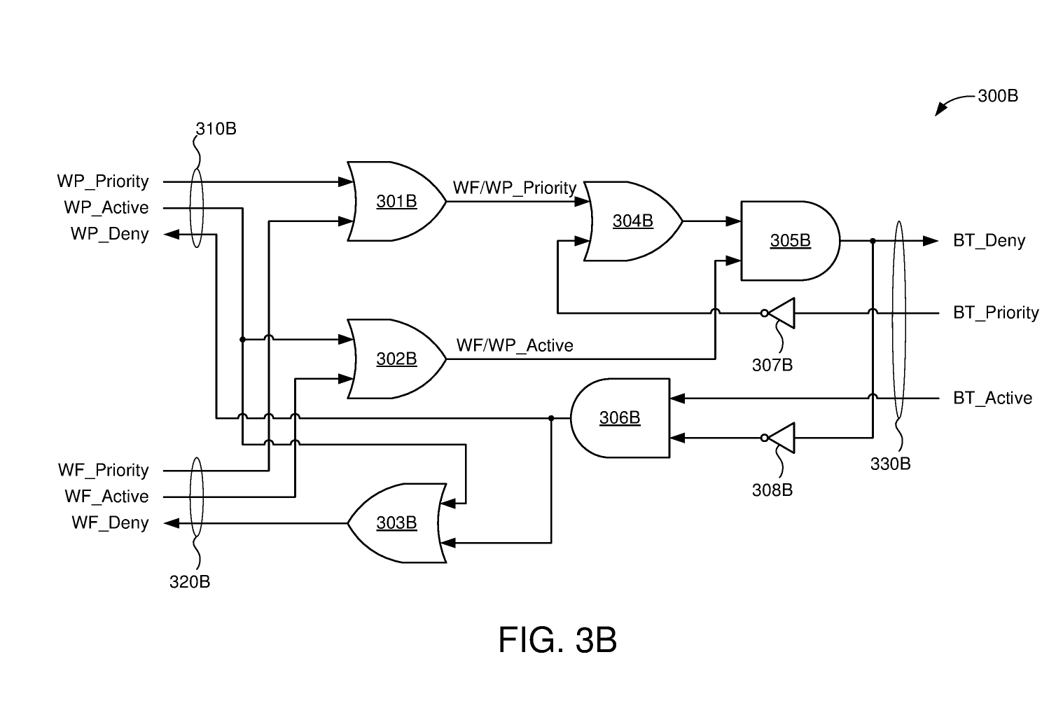

The coexistence interface 240 may receive activity indication signals 212, 222, and 232 from the wireless radios 210, 220, and 230, respectively. Specifically, the coexistence interface 240 may receive Wi-Fi activity (WFA) signals 212 from the Wi-Fi radio 210, Bluetooth activity (BA) signals 222 from the Bluetooth radio 220, and WPAN activity (WPA) signals 232 from the WPAN radio 230. The activity indication signals 212, 222, and 232 may indicate transmit and/or receive activity by the respective wireless radios 210, 220, and 230. For example, the Wi-Fi radio 210 may assert the WFA signals 212 to indicate that the Wi-Fi radio 210 is transmitting and/or receiving Wi-Fi signals. The Bluetooth radio 220 may assert the BA signals 222 to indicate that the Bluetooth radio 220 is transmitting and/or receiving Bluetooth signals. The WPAN radio 230 may assert the WPA signals 232 to indicate that the WPAN radio 230 is transmitting and/or receiving WPAN signals. For some embodiments, the activity indication signals 212, 222, and 232 may further indicate a priority of the transmit and/or receive activity being performed by the wireless radios 210, 220, and 230, respectively (e.g., as described in greater detail below with respect to FIGS. 3A-3B).

The coexistence interface 240 may provide control signals 213, 223, and 233 to the wireless radios 210, 220, and 230, respectively. In example embodiments, the control signals 213, 223, and 233 may be used to enable and/or disable wireless communications by the respective wireless radios 210, 220, and 230. For example, the coexistence interface 240 may assert the wireless Wi-Fi control (WFC) signal 213 to prevent the Wi-Fi radio 210 from transmitting and/or receiving Wi-Fi signals. The coexistence interface 240 may assert the Bluetooth control (BC) signal 223 to prevent the Bluetooth radio 220 from transmitting and/or receiving Bluetooth signals. The coexistence interface 240 may assert the WPAN control (WPC) signal 233 to prevent the WPAN radio 230 from transmitting and/or receiving WPAN signals.

In example embodiments, the coexistence interface 240 may assert one or more of the control signals 213, 223, and/or 233 based at least in part on a combination of the activity indication signals 212, 222, and/or 232. For example, it may be desirable to prevent the Wi-Fi radio 210 from transmitting and/or receiving Wi-Fi signals if the Bluetooth radio 220 or the WPAN radio 230 is transmitting and/or receiving wireless signals. Similarly, it may be desirable to prevent the Bluetooth radio 220 and WPAN radio 230 from transmitting and/or receiving wireless signals if the Wi-Fi radio 210 is transmitting and/or receiving Wi-Fi signals. Thus, the coexistence interface 240 may assert the WFC signal 213 if the WPA signals 232 and/or BA signals 222 are asserted, and may assert the BC signal 223 and WPC signal 233 if the WFA signals 212 are asserted. An example operation of the coexistence interface 240, in accordance with the foregoing embodiment, is summarized in Table 1, below.

TABLE 1

| TX/RX | WFA | BA | WPA | WFC | BC | WPC | Active |
|---|---|---|---|---|---|---|---|
| Attempt | 212 | 222 | 232 | 213 | 223 | 233 | Radio |
| None | 0 | 0 | 0 | 0 | 0 | 0 | N/A |
| WPAN | 0 | 0 | 1 | 1 | 1 | 0 | WPAN 230 |
| Bluetooth | 0 | 1 | 0 | 1 | 0 | 0 | BT 220 |
| Bluetooth + | 0 | 1 | 1 | 1 | 1 | 0 | WPAN 230 |
| WPAN | | | | | | | |
| Wi-Fi | 1 | 0 | 0 | 0 | 1 | 1 | Wi-Fi 210 |
| Wi-Fi + | 1 | 0 | 1 | 1 | 1 | 0 | WPAN 230 |
| WPAN | | | | | | | |
| Wi-Fi + | 1 | 1 | 0 | 1 | 0 | 0 | BT 220 |
| Bluetooth | | | | | | | |
| Wi-Fi + | 1 | 1 | 1 | 1 | 1 | 0 | WPAN 230 |
| Bluetooth + | | | | | | | |
| WPAN | | | | | | | |

In the example illustrated in Table 1, the WPAN radio 230 takes priority over the Bluetooth radio 220 and Wi-Fi radio 210, and the Bluetooth radio 220 takes priority over the Wi-Fi radio 210. For example, the Wi-Fi radio and Bluetooth radio 220 are prevented from transmitting and/or receiving wireless signals (e.g., WFC 213=1 and BC 223=1) when the WPAN radio 230 is transmitting and/or receiving WPAN signals (e.g., WPA 232=1). Further, the Wi-Fi radio 210 is further prevented from transmitting and/or receiving Wi-Fi signals (e.g., WFC 213=1) when the Bluetooth radio 220 is transmitting and/or receiving Bluetooth signals (e.g., BA 222=1).

For some implementations, it may be desirable to prioritize Wi-Fi communications over Bluetooth communications. For example, it may be desirable to prevent the Bluetooth radio 220 from transmitting and/or receiving Bluetooth signals if the Wi-Fi radio 210 or the WPAN radio 230 is transmitting and/or receiving wireless signals. Thus, in an alternative embodiment, the coexistence interface 240 may assert the BC signal 223 if the WPA signals 232 and/or WFA signals 212 are asserted, and may assert the WFC signals 213 and WPC signal 233 if the BA signals 222 are asserted. An example operation of the coexistence interface 240, in accordance with the foregoing embodiment, is summarized in Table 2, below.

TABLE 2

| TX/RX | WFA | BA | WPA | WFC | BC | WPC | Active |
|---|---|---|---|---|---|---|---|
| Attempt | 212 | 222 | 232 | 213 | 223 | 233 | Radio |
| None | 0 | 0 | 0 | 0 | 0 | 0 | N/A |
| WPAN | 0 | 0 | 1 | 1 | 1 | 0 | WPAN 230 |
| Wi-Fi | 1 | 0 | 0 | 0 | 1 | 0 | Wi-Fi 210 |
| Wi-Fi + | 1 | 0 | 1 | 1 | 1 | 0 | WPAN 230 |
| WPAN | | | | | | | |
| Bluetooth | 0 | 1 | 0 | 1 | 0 | 1 | BT 220 |
| Wi-Fi + | 1 | 0 | 1 | 1 | 1 | 0 | WPAN 230 |
| WPAN | | | | | | | |
| Wi-Fi + | 1 | 1 | 0 | 0 | 1 | 0 | Wi-Fi 210 |
| Bluetooth | | | | | | | |
| Wi-Fi + | 1 | 1 | 1 | 1 | 1 | 0 | WPAN 230 |
| Bluetooth + | | | | | | | |
| WPAN | | | | | | | |

The example priorities given to each of the wireless radios 210, 220, and 230 are for illustrative purposes only. In other embodiments, the wireless radios 210, 220, and/or 230 (e.g., and/or any additional wireless radios not shown in FIG. 2, for simplicity) may be assigned different priorities, for example, by coupling the wireless radios 210, 220, and/or 230 to different sets of inputs and outputs 1-3 of the coexistence interface 240. As described above, the example embodiments may be used to prioritize wireless communication technologies in a hierarchical manner. In some aspects, the activity indication signals for the highest-priority wireless technologies (e.g., WPAN+Bluetooth or WPAN+Wi-Fi) may be combined to disable and/or enable communications using lower-priority wireless technologies (e.g., Wi-Fi or Bluetooth).

As described above, the coexistence interface 240 may provide coexistence functionality for legacy wireless radios (e.g., Wi-Fi radio 210) that do not have pre-defined or built-in coexistence logic. For example, the coexistence interface 240 may prioritize the transmit and/or receive activity of certain wireless radios over that of other wireless radios. In example embodiments, the coexistence interface 240 may prioritize transmit and/or receive activity of the Wi-Fi radio 210 based at least in part on the transmit or receive activity of the WPAN radio 230 and BT radio 220 (e.g., based on a logical combination of the WPA signal 232 and BA signal 222, respectively). In some aspects, transmit and receive activity of either the WPAN radio 230 or the BT radio 220 may take priority over transmit or receive activity of the Wi-Fi radio 210 (e.g., as illustrated in Table 1). In other aspects, receive activity of the Wi-Fi radio 210 may take priority over transmit or receive activity of the WPAN radio 230 and BT radio 220, which may take priority over transmit activity of the Wi-Fi radio 210.

FIGS. 3A-3B show circuit diagrams of respective coexistence interfaces 300A and 300B in accordance with example embodiments. Each of the coexistence interfaces 300A and 300B may be one embodiment of the coexistence interface 240 of FIG. 2. Thus, the coexistence interfaces 300A and 300B may control and/or arbitrate wireless activity from a plurality of wireless radios (e.g., wireless radios 210, 220, and 230 of FIG. 2).

Each coexistence interface 300A and 300B includes a respective first set of input and output (I/O) ports 310A and 310B, second set of I/O ports 320A and 320B, and third set of I/O ports 330A and 330B. Each set of I/O ports may be coupled to a respective wireless radio. In the example of FIG. 3A, a WPAN radio is coupled to the coexistence interface 300A via the first set of I/O ports 310A; a Bluetooth radio is coupled to the coexistence interface 300A via the second set of I/O ports 320A; and a Wi-Fi radio is coupled to the coexistence interface 300A via the third set of I/O ports 330A. In the example of FIG. 3B, a WPAN radio is coupled to the coexistence interface 300B via the first set of I/O ports 310B; a Wi-Fi radio is coupled to the coexistence interface 300B via the second set of I/O ports 320B; and a Wi-Fi radio is coupled to the coexistence interface 300B via the third set of I/O ports 330B.

Each coexistence interface 300A and 300B may receive Wi-Fi activity indication signals (WF_Active and WF_Priority) from a Wi-Fi radio, Bluetooth activity indication signals (BT_Active and BT_Priority) from a Bluetooth radio, and WPAN activity indication signals (WP_Active and WP_Priority) from a WPAN radio. The activity indication signals from each wireless radio may include an “active” signal and a “priority” signal for the corresponding wireless radio. For example, the WF_Active and WF_Priority signals may correspond to the WFA signals 212 (e.g., from Wi-Fi radio 210) of FIG. 2, the BT_Active and BT_Priority signals may correspond to the BA signals 222 (e.g., from Bluetooth radio 220), and the WP_Active and WP_Priority signals may correspond to WPA signals 232 (e.g., from WPAN radio 230).

The active signals may indicate ongoing transmit and/or receive activity of the respective wireless radios. For example, assertion of the WF_Active signal may indicate that the Wi-Fi radio is transmitting and/or receiving Wi-Fi signals, and deassertion of the WF_Active signal may indicate that the Wi-Fi radio is not transmitting or receiving Wi-Fi signals. Assertion of the BT_Active signal may indicate that the Bluetooth radio is transmitting and/or receiving Bluetooth signals, and deassertion of the BT_Active signal may indicate that the Bluetooth radio is not transmitting or receiving Bluetooth signals. Assertion of the WP_Active signal may indicate that the WPAN radio is transmitting and/or receiving WPAN signals, and deassertion of the WP_Active signal may indicate that the WPAN radio is not transmitting or receiving WPAN signals.

The priority signals may indicate a priority of the transmit and/or receive activity of the respective wireless radios. For example, assertion of the WF_Priority signal may indicate that the transmit and/or receive activity of the Wi-Fi radio is high-priority, and deassertion of the WF_Priority signal may indicate that the transmit and/or receive activity of the Wi-Fi radio is low-priority. Assertion of the BT_Priority signal may indicate that the transmit and/or receive activity of the Bluetooth radio is high-priority, and deassertion of the BT_Priority signal may indicate that the transmit and/or receive activity of the Bluetooth radio is low-priority. Assertion of the WP_Priority signal may indicate that the transmit and/or receive activity of the WPAN radio is high-priority, and deassertion of the WP_Priority signal may indicate that the transmit and/or receive activity of the WPAN radio is low-priority.

In example embodiments, each coexistence interface 300A and 300B may generate control signals (WF_Deny, BT_Deny, and WP_Deny) based on the activity indication signals. For example, the WF_Deny signal may correspond to the WFC signal 213 of FIG. 2, the BT_Deny signal may correspond to the BC signal 223, and the WP_Deny signal may correspond to the WPC signal 233. As described above, the control signals may be used to enable and/or disable transmit and receive activity by the respective wireless radios. For example, assertion of the Wi-Fi control (WF_Deny) signal may prevent the Wi-Fi radio from transmitting and/or receiving wireless signals. Further, assertion of the Bluetooth control (BT_Deny) signal may prevent the Bluetooth radio from transmitting and/or receiving wireless signals. Still further, assertion of the WPAN control (WP_Deny) signal may prevent the WPAN radio from transmitting and/or receiving wireless signals. Each coexistence interface 300A and 300B may generate the control signals WF_Deny, BT_Deny, and WP_Deny based on logical combinations of the activity indication signals WL_Active/Priority, BT_Active/Priority, and WP_Active/Priority.

In example embodiments, the coexistence interfaces 300A and 300B may be implemented via a plurality of logic gates 301A-306A and 301B-306B, respectively. More specifically, the plurality of logic gates 301A-306A and 301B-306B may include “OR” logic gates 301A-304A and 301B-304B that perform logical OR operations, and “AND” logic gates 305A-306A and 305B-306B that perform logical AND operations. With reference to FIG. 3A, logic gate 301A may generate a combined priority (BT/WP_Priority) signal based on a logical OR combination of the BT_Priority and WP_Priority signals, and logic gate 302A may generate a combined active (BT/WP_Active) signal based on a logical OR combination of the BT_Active and WP_Active signals. For some embodiments, inverters 307A and 308A may be coupled to respective inputs of logic gates 304A and 306A. More specifically, inverter 307A may invert the logical representation of the WF_Priority signal, and inverter 308A may invert the logical representation of the WF_Deny signal. An example operation of the coexistence interface 300A (e.g., and logic gates 301A-306A), in accordance with the foregoing embodiment, is summarized in Table 3, below.

TABLE 3

| WF_Active | BT/WP_Active | BT/WP_Priority | WF_Priority | WF_Deny | Wi-Fi |
|---|---|---|---|---|---|
| (Input) | (Inputs) | (Inputs) | (Input) | (Output) | TX? |
| 1 | 0 | N/A | N/A | 0 | Yes |
| 1 | 1 | 0 | 0 | 1 | No |
| 1 | 1 | 1 | 0 | 1 | No |
| 1 | 1 | 0 | 1 | 0 | Yes |
| 1 | 1 | 1 | 1 | 1 | No |

In the example illustrated in Table 3, transmit and receive activity of the Bluetooth and WPAN radios take priority over transmit activity of the Wi-Fi radio. For example, the Wi-Fi radio is prevented from transmitting Wi-Fi signals (e.g., WF_Deny=1) when the Bluetooth radio or WPAN radio is transmitting and/or receiving high-priority signals (e.g., BT/WP_Active=1 and BT/WP_Priority=1). If the Bluetooth radio or WPAN radio is transmitting and/or receiving low-priority signals (e.g., BT/WP_Active=1 and BT/WP_Priority=0) and the Wi-Fi radio is also attempting to transmit low-priority data (e.g., WF_Priority=0), the Wi-Fi radio may be prevented from transmitting its data (e.g., WF_Deny=1). However, if the Bluetooth or WPAN radio is transmitting and/or receiving low-priority signals (e.g., BT/WP_Active=1 and BT/WP_Priority=0) and the Wi-Fi radio is attempting to transmit high-priority data (e.g., WF_Priority=1), the Wi-Fi radio may be allowed to transmit its data (e.g., WF_Deny=0).

Alternative implementations may prioritize Wi-Fi communications over Bluetooth communications. For example, with reference to the coexistence interface 300B of FIG. 3B, logic gate 301B may generate a combined priority (WF/WP_Priority) signal based on a logical OR combination of the WF_Priority and WP_Priority signals, and logic gate 302B may generate a combined active (WF/WP_Active) signal based on a logical OR combination of the WF_Active and WP_Active signals. Furthermore, inverter 307B may invert the logical representation of the BT_Priority signal, and inverter 308B may invert the logical representation of the BT_Deny signal. An example operation of the coexistence interface 300B (e.g., and logic gates 301B-306B), in accordance with the foregoing embodiment, is summarized in Table 4, below.

TABLE 4

| BT_Active | WF/WP_Active | WF/WP_Priority | BT_Priority | BT_Deny | BT |
|---|---|---|---|---|---|
| (Input) | (Inputs) | (Inputs) | (Input) | (Output) | TX? |
| 1 | 0 | N/A | N/A | 0 | Yes |
| 1 | 1 | 0 | 0 | 1 | No |
| 1 | 1 | 1 | 0 | 1 | No |
| 1 | 1 | 0 | 1 | 0 | Yes |
| 1 | 1 | 1 | 1 | 1 | No |

In the example illustrated in Table 4, transmit and receive activity of the Wi-Fi and WPAN radios take priority over transmit activity of the Bluetooth radio. For example, the Bluetooth radio is prevented from transmitting Bluetooth signals (e.g., BT_Deny=1) when the Wi-Fi radio or WPAN radio is transmitting and/or receiving high-priority signals (e.g., WF/WP_Active=1 and WF/WP_Priority=1). If the Wi-Fi radio or WPAN radio is transmitting and/or receiving low-priority signals (e.g., WF/WP_Active=1 and WF/WP_Priority=0) and the Bluetooth radio is also attempting to transmit low-priority data (e.g., BT_Priority=0), the Bluetooth radio may be prevented from transmitting its data (e.g., BT_Deny=1). However, if the Wi-Fi or WPAN radio is transmitting and/or receiving low-priority signals (e.g., WF/WP_Active=1 and WF/WP_Priority=0) and the Bluetooth radio is attempting to transmit high-priority data (e.g., BT_Priority=1), the Bluetooth radio may be allowed to transmit its data (e.g., BT_Deny=0).

The example embodiments recognize that, due to timing constraints, it may be desirable to implement the coexistence interfaces 300A and 300B in hardware (e.g., using hardwired logic gates 301A-306A and 301B-306B, as shown in FIGS. 3A and 3B), rather than software (e.g., executing on one or more processors and/or ASICs). As discussed above, Bluetooth radios and WPAN radios are more likely to support coexistence, whereas many legacy Wi-Fi radios may not provide coexistence support. Thus, for some embodiments, the WF_Deny signal may be coupled directly to a power amplifier and/or other wireless signal generation circuitry of the Wi-Fi radio to selectively enable and/or disable the transmission and/or reception of Wi-Fi signals.

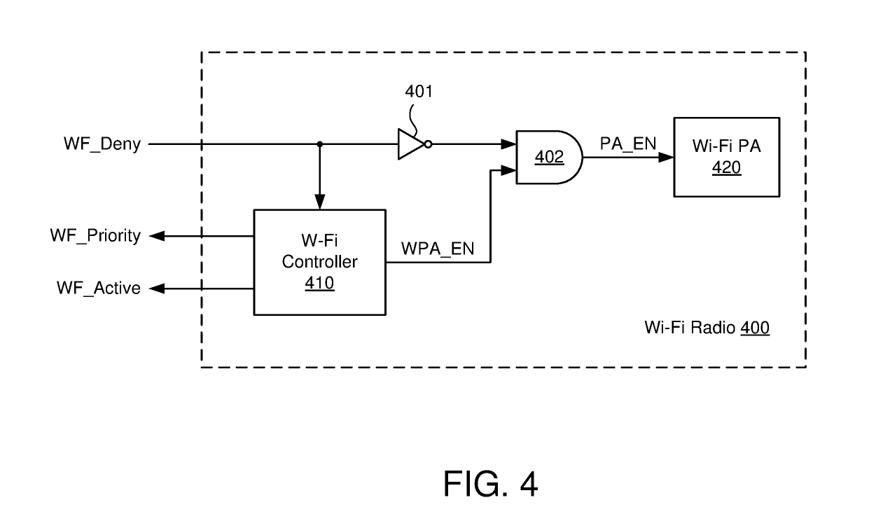

FIG. 4 is a block diagram of a Wi-Fi radio 400 in accordance with example embodiments. The Wi-Fi radio 400 may be one embodiment of the Wi-Fi radio 210 of FIG. 2. In some aspects, the Wi-Fi radio 400 may be a legacy Wi-Fi radio without native coexistence support. The Wi-Fi radio 400 includes a Wi-Fi controller 410 and a Wi-Fi power amplifier (PA) 420.

The Wi-Fi controller 410 may control a transmission and/or reception of Wi-Fi signals by the Wi-Fi radio 400. For example, when attempting to transmit or receive Wi-Fi signals, the Wi-Fi controller 400 may assert the WF_Active signal and a power amplifier enable (WPA_EN) signal to activate or enable the Wi-Fi power amplifier 420. In some aspects, the Wi-Fi controller 410 may selectively assert the WF_Priority signal based on a priority of the data to be transmitted and/or received by the Wi-Fi radio 400. The priority may be determined by the Wi-Fi controller 410 based on a number of factors including, for example, data type, data length, target device, access category (e.g., as defined by the IEEE 802.11e specification), etc. For example, beacon frames may be given high-priority status. Further, voice data (AC_VO) and video data (AC_VI) may also be given high-priority status, whereas background data (AC_BK) and best effort data (AC_BE) may be given low-priority status.

In example embodiments, the Wi-Fi controller 410 is coupled to receive the WL_Deny signal (e.g., from coexistence interface 300A or 300B). More specifically, the Wi-Fi controller 410 may control the transmit and/or receive activity of the Wi-Fi radio 400 based at least in part on the WF_Deny signal. For example, the Wi-Fi controller 410 may refrain from transmitting and/or receiving Wi-Fi signals (e.g., and cease any ongoing transmissions) if the WF_Deny signal is asserted. Still further, in some embodiments, the WF_Deny signal may be coupled to the Wi-Fi PA 420 via a logic gate 402.

The logic gate 402 combines the WF_Deny signal with the WPA_EN signal, via a logical AND operation, to generate a power amplifier (PA_EN) signal that may be used to control the Wi-Fi power amplifier 420. Specifically, an inverter 401 may be coupled to a respective input of the logic gate 402 to provide an inverted logical representation of the WF_Deny signal to the input of the logic gate 402. Accordingly, the PA_EN signal is effectively “gated” by the WL_Deny signal. For example, as shown in FIG. 4, the PA_EN signal may be asserted only when the WPA_EN signal is asserted (e.g., indicating transmit activity by the Wi-Fi radio 400) and the WL_Deny signal is deasserted (e.g., indicating no transmit activity by any other wireless radios of a corresponding wireless hub).

In some embodiments, the Wi-Fi controller 410 may configure or adjust the priority of the data to be transmitted by the Wi-Fi radio 400 based at least in part on transmit or receive activity of other wireless radios in the wireless hub (e.g., WPAN radio 230 and BT radio 220 of FIG. 2). For example, in some aspects, the Wi-Fi controller 410 may de-prioritize the transmission of Wi-Fi signals over Bluetooth and/or WPAN communications. Thus, upon detecting that the WF_Deny signal is asserted (e.g., indicating transmit and/or receive activity by the WPAN radio 230 and/or BT radio 220), the Wi-Fi controller 410 may deassert the WF_Priority signal to decrease the priority of Wi-Fi transmissions.

In other aspects, the Wi-Fi controller 410 may attempt to prioritize the transmission of Wi-Fi signals over Bluetooth and/or WPAN communications. Thus, upon detecting that the WF_Deny signal is asserted, the Wi-Fi controller 410 may assert the WF_Priority signal to increase the priority of Wi-Fi transmissions. In the configuration of FIG. 3A (and with reference to Table 3), if the WP_Priority and BT_Priority signals are deasserted while the WF_Priority signal is asserted, the WF_Deny signal may be subsequently deasserted (e.g., thus enabling the Wi-Fi radio 400 to transmit, or continue transmitting, its Wi-Fi signals). In the configuration of FIG. 3B (and with reference to Table 4), the WF_Deny signal may be deasserted as long as the WF_Priority and WF_Active signals are asserted and the WP_Active signal is deasserted.

FIG. 5 is a block diagram of a coexistence interface 500 in accordance with example embodiments. The coexistence interface 500 may be an embodiment of the coexistence interface 240 of FIG. 2. The coexistence interface 500 may include a wireless radio (WR) interface 510, a processor 520, and a memory 530. For purposes of discussion herein, processor 520 is shown in FIG. 5 as being coupled between the WR interface 510 and memory 530. For actual embodiments, the WR interface 510, processor 520, and/or memory 530 may be connected together using one or more buses (not shown for simplicity).

The WR interface 510 may be coupled to a plurality of wireless radios (not shown for simplicity). In example embodiments, the plurality of wireless radios may include at least a Wi-Fi radio, a Bluetooth radio, and a WPAN radio. The WR interface 510 may receive activity indication signals from each of the plurality of wireless devices via a respective inputs of the WR interface 510. As described above, the activity indication signals may indicate transmit and/or receive activity of a corresponding wireless radio, and may include priority information for the transmit and/or receive activity. Further, the WR interface 510 may output control signals to the plurality of wireless radios via respective outputs of the WR interface 510. As described above, the control signals may enable and/or disable wireless communications by a corresponding wireless radio.

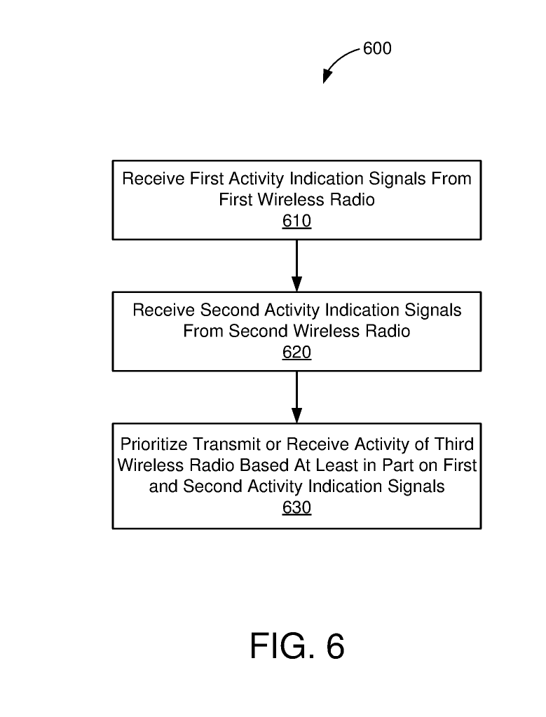

Memory 530 may include a non-transitory computer-readable medium (e.g., one or more nonvolatile memory elements, such as EPROM, EEPROM, Flash memory, a hard drive, and so on) that may store at least the following software (SW) modules:
a wireless radio (WR) arbitration SW module 532 to arbitrate wireless communications among the plurality of wireless radios based at least in part on their respective wireless technologies;
   a Wi-Fi (WF) arbitration SW module 533 to prioritize the transmit and/or receive activity of the Wi-Fi radio based at least in part on the transmit and/or receive activity of the WPAN and Bluetooth radios (e.g., as described above with respect to FIGS. 2, 3A, and 4); and
   a Bluetooth (BT) arbitration SW module 534 to prioritize the transmit and/or receive activity of the Bluetooth radio based at least in part on the transmit and/or receive activity of the WPAN and Wi-Fi radios (e.g., as described above with respect to FIGS. 2 and 3B).
      Each software module includes instructions that, when executed by processor 520, causes the coexistence interface 500 to perform the corresponding functions. The non-transitory computer-readable medium of memory 530 thus includes instructions for performing all or a portion of the operations described below with respect to FIG. 6.

Processor 520 may be any suitable one or more processors capable of executing scripts or instructions of one or more software programs stored in the coexistence interface 500 (e.g., within memory 530). For example, processor 520 may execute the WR arbitration SW module 532 to arbitrate wireless communications among the plurality of wireless radios based at least in part on their respective wireless technologies. In executing the WR arbitration SW module 532, the processor 520 may further execute the WF arbitration SW module 533 and/or BT arbitration SW module 534.

For example, the processor 520 may execute the WF arbitration SW module 533 to prioritize the transmit and/or receive activity of the Wi-Fi radio based at least in part on the transmit and/or receive activity of the WPAN and Bluetooth radios (e.g., as described above with respect to FIGS. 2, 3A, and 4). The processor 520 may also execute the BT arbitration SW module 534 to prioritize the transmit and/or receive activity of the Bluetooth radio based at least in part on the transmit and/or receive activity of the WPAN and Wi-Fi radios (e.g., as described above with respect to FIGS. 2 and 3B).

FIG. 6 is an illustrative flow chart depicting an example operation 600 of a coexistence interface in accordance with example embodiments. In some aspects, the operation 600 may be performed by the coexistence interface 240 of FIG. 2 and/or coexistence interfaces 300A or 300B of FIGS. 3A-3B. With reference for example to FIG. 2, the operation 600 may be performed by the coexistence interface 240 to control and/or arbitrate wireless activity from each of the wireless radios 210, 220, and 230. In other aspects, the operation 600 may be implemented as a set of instructions to be executed by one or more processors (not shown for simplicity). Still further, in some aspects, the operation 600 may be applicable to the design stage and/or the manufacturing stage of a printed circuit board (PCB) construction process.

The coexistence interface 240 may receive first activity indication signals from a first wireless radio (610). In example embodiments, the coexistence interface 240 may receive WPAN activity (WPA) signals 232 from the WPAN radio 230. The WPA signals 232 may indicate transmit and/or receive activity of the WPAN radio 230. For example, the WPAN radio 230 may assert the WPA signals 232 to indicate that the WPAN radio 230 is transmitting and/or receiving WPAN signals. In some aspects, the WPA signals 232 may further indicate a priority of the transmit and/or receive activity of the WPAN radio 230 (e.g., as described in greater detail with respect to FIGS. 3A-3B).

The coexistence interface 240 may further receive second activity indication signals from a second wireless radio (620). In example embodiments, the coexistence interface 240 may receive Bluetooth activity (BA) signals 222 from the Bluetooth radio 220. The BA signals 222 may indicate transmit and/or receive activity of the Bluetooth radio 220. For example, the Bluetooth radio 220 may assert the BA signals 222 to indicate that the Bluetooth radio 220 is transmitting and/or receiving Bluetooth signals. In some aspects, the BA signals 222 may further indicate a priority of the transmit and/or receive activity of the Bluetooth radio 220 (e.g., as described in greater detail with respect to FIGS. 3A-3B).

The coexistence interface 240 may prioritize transmit or receive activity of a third wireless radio based at least in part on the first and second activity indication signals (630). In example embodiments, the coexistence interface 240 may generate a Wi-Fi control (WFC) signal 213 based at least in part on a logical combination of the WPA signals 232 and BA signals 222. The WFC signal 213 may be used to enable and/or disable wireless communications by the Wi-Fi radio 210. For example, the coexistence interface 240 may assert the WFC signal 213 to prevent the Wi-Fi radio 210 from transmitting and/or receiving Wi-Fi signals (e.g., as described in greater detail with respect to FIG. 4). In the example illustrated in Table 1, the coexistence interface 240 may assert the WFC signal 213 if the ZA signals 232 and/or BA signals 222 are asserted. In this manner, the coexistence interface 240 may prevent the Wi-Fi radio 210 from interfering with communications by the Bluetooth radio 220 and/or WPAN radio 230.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A coexistence interface for a wireless device, the coexistence interface comprising:
a first set of inputs to receive first signals indicating transmit or receive activity of a first wireless radio of the wireless device;
a second set of inputs to receive second signals indicating transmit or receive activity of a second wireless radio of the wireless device; and
arbitration logic to prioritize transmit or receive activity of a third wireless radio of the wireless device based at least in part on the first and second signals.

2. The coexistence interface of claim 1, wherein the first wireless radio operates in accordance with a first wireless communications protocol, and wherein the second wireless radio operates in accordance with a second wireless communications protocol that is different than the first wireless communications protocol.

3. The coexistence interface of claim 2, wherein the first wireless communications protocol is a Bluetooth protocol and the second wireless communications protocol is a wireless personal area network (WPAN) protocol defined by the IEEE 802.15.4 standard.

4. The coexistence interface of claim 3, wherein the arbitration logic is to further:
adjust the transmit or receive activity of the first wireless radio based at least in part on the second signals.

5. The coexistence interface of claim 2, wherein the third wireless radio operates in accordance with a third wireless communications protocol that is different than the first and second wireless communications protocols.

6. The coexistence interface of claim 4, wherein the third wireless communications protocol is a wireless local area network (WLAN) or Wi-Fi protocol defined by the IEEE 802.11 standard.

7. The coexistence interface of claim 1, wherein the third wireless radio is a legacy Wi-Fi radio.

8. The coexistence interface of claim 1, wherein the first signals further indicate a priority of the transmit or receive activity of the first wireless radio, and wherein the second signals further indicate a priority of the transmit or receive activity of the second wireless radio.

9. The coexistence interface of claim 1, further comprising:
a third set of inputs to receive third signals indicating transmit or receive activity of the third wireless radio, and wherein the third signals further indicate a priority of the transmit or receive activity of the third wireless radio.

10. The coexistence interface of claim 9, wherein the arbitration logic is to prioritize the transmit or receive activity of the third wireless radio by selectively outputting a control signal to the third wireless radio.

11. The coexistence interface of claim 10, wherein the arbitration logic comprises:
a plurality of logic gates to generate the control signal based on a logical combination of the first, second, and third signals.

12. The coexistence interface of claim 10, wherein the arbitration logic is to further:
disable the transmit or receive activity of the third wireless radio by asserting the control signal; and
enable the transmit or receive activity of the third wireless radio by deasserting the control signal.

13. The coexistence interface of claim 10, wherein the arbitration logic is coupled to a power amplifier of the third wireless radio, to selectively activate or deactivate the power amplifier based on the control signal.

14. A method of arbitrating wireless communications among a plurality of wireless radios of a wireless device, the method comprising:
receiving first signals indicating transmit or receive activity of a first wireless radio of the wireless device;
receiving second signals indicating transmit or receive activity of a second wireless radio of the wireless device; and
prioritizing transmit or receive activity of a third wireless radio of the wireless device based at least in part on the first and second signals.

15. The method of claim 14, wherein the first wireless radio operates in accordance with a Bluetooth protocol and the second wireless radio operates in accordance with a wireless personal area network (WPAN) protocol defined by the IEEE 802.15.4 standard.

16. The method of claim 15, further comprising:
adjusting the transmit or receive activity of the first wireless radio based at least in part on the second signals.

17. The method of claim 15, wherein the third wireless radio operates in accordance with a wireless local area network (WLAN) or Wi-Fi protocol defined by the IEEE 802.11 standard.

18. The method of claim 14, wherein the third wireless radio is a legacy Wi-Fi radio.

19. The method of claim 14, wherein the first signals further indicate a priority of the transmit or receive activity of the first wireless radio, and wherein the second signals further indicate a priority of the transmit or receive activity of the second wireless radio.

20. The method of claim 14, further comprising:
receiving third signals indicating transmit or receive activity of the third wireless radio, wherein the third signals further indicate a priority of the transmit or receive activity of the third wireless radio.

21. The method of claim 14, wherein the prioritizing comprises:
selectively activating or deactivating a power amplifier of the third wireless radio based at least in part on the first and second signals.

22. A coexistence interface for a wireless device, the coexistence interface comprising:
means for receiving first signals indicating transmit or receive activity of a first wireless radio of the wireless device;
means for receiving second signals indicating transmit or receive activity of a second wireless radio of the wireless device; and
means for prioritizing transmit or receive activity of a third wireless radio of the wireless device based at least in part on the first and second signals.

23. The coexistence interface of claim 22, wherein the first wireless radio operates in accordance with a Bluetooth protocol and the second wireless radio operates in accordance with a wireless personal area network (WPAN) protocol defined by the IEEE 802.15.4 standard.

24. The coexistence interface of claim 23, further comprising:
means for adjusting the transmit or receive activity of the first wireless radio based at least in part on the second signals.

25. The coexistence interface of claim 23, wherein the third wireless radio operates in accordance with a wireless local area network (WLAN) or Wi-Fi protocol defined by the IEEE 802.11 standard.

26. The coexistence interface of claim 22, wherein the third wireless radio is a legacy Wi-Fi radio.

27. The coexistence interface of claim 22, wherein the first signals further indicate a priority of the transmit or receive activity of the first wireless radio, and wherein the second signals further indicate a priority of the transmit or receive activity of the second wireless radio.

28. The coexistence interface of claim 22, further comprising:
means for receiving third signals indicating transmit or receive activity of the third wireless radio, wherein the third signals further indicate a priority of the transmit or receive activity of the third wireless radio.

29. The coexistence interface of claim 22, wherein the means for prioritizing the transmit or receive activity of the third wireless radio is to:
selectively activate or deactivate a power amplifier of the third wireless radio based at least in part on the first and second signals.

30. A non-transitory computer-readable storage medium storing instructions that, when executed by one or more processors of a wireless device, cause the wireless device to:
receive first signals indicating transmit or receive activity of a first wireless radio of the wireless device;
receive second signals indicating transmit or receive activity of a second wireless radio of the wireless device; and
prioritize transmit or receive activity of a third wireless radio of the wireless device based at least in part on the first and second signals.
